(19) United States
(12) Patent Application Publication
(10) Pub. No.: US 2006/0009720 A1
(43) Pub. Date: Jan. 12, 2006

(54) Abdominal fitness equipment installable on a chair

(76) Inventor: Hung-Chun Chung, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/887,500

(22) Filed: Jul. 7, 2004

(51) Int. Cl. A61H 11/00; A61H 19/00

(52) U.S. Cl. 601/143; 601/144

(57) ABSTRACT

An abdominal fitness equipment installable on a chair, whereby a main body and vibrating belts of a conventional abdominal fitness equipment are installed on the chair. A user sits on the chair, and can utilize the abdominal fitness equipment to achieve body shaping of the abdomen or waist.

### BACKGROUND OF THE INVENTION

(a) Field of the Invention

The present invention relates to an abdominal fitness equipment installable on a chair, whereby a main body and vibrating belts of a conventional abdominal fitness equipment are installed on the chair. A user sits on the chair, and can utilize the abdominal fitness equipment to achieve body shaping of the abdomen or waist.

(b) Description of the Prior Art

A conventional abdominal fitness equipment is provided with a vibrating belt connected to one side of a main body. A user necessarily stands on a platform, and wraps the vibrating belt around the abdomen or the waist, and utilizes continuous vibration of the vibrating belt to achieve objective of body shaping. However, the conventional abdominal fitness equipment is very large, and apart from placing the abdominal fitness equipment in a gymnasium or home, an average office worker subject to space limitations is unable to use such abdominal fitness equipment.

### SUMMARY OF THE INVENTION

A primary objective of the present invention is to install a main body of a conventional abdominal fitness equipment on a rear side of a chair, and vibrating belts configured on two sides of the main body can thus wrap round the abdomen or the waist of a user when the user sits on the chair, with which achieves effectiveness of body shaping the abdomen or the waist.

Another objective of the present invention is to effectuate concealing the main body of the fitness equipment in a chair-back, thus only exposing a switch and the vibrating belts, and thereby forming a fitness chair provided with abdomen body shaping functionality.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general schematic view according to the present invention.

FIG. 2 shows a schematic view of another embodiment according to the present invention.

FIG. 3 shows a structural schematic view of a main body according to the present invention.

FIG. 4 shows a schematic view of an embodiment of an axle according to the present invention.

### DETAILED DESCRIPTION OF THE PREFERRED EMBODIMENTS

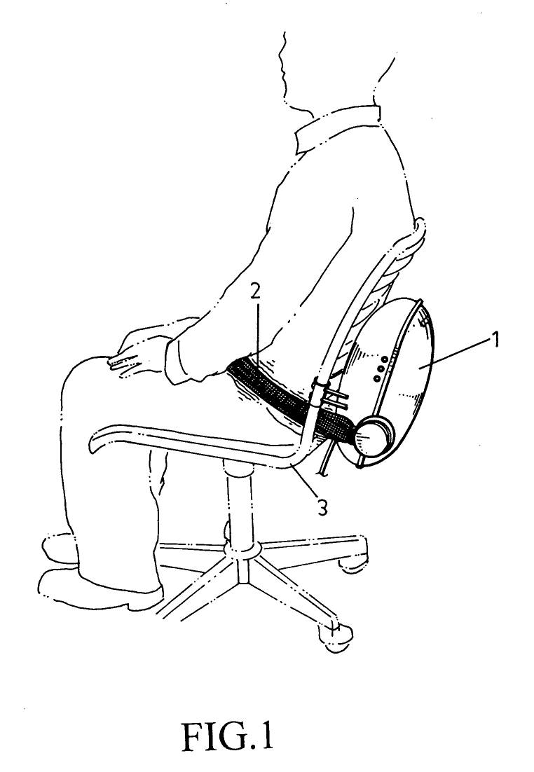

Referring to FIG. 1, which shows the present invention excluding a platform of a conventional abdominal fitness equipment, and whereby a main body 1 and a vibrating belt 2 of the fitness equipment are dismantled so as to install same on a conventional chair 3, thereby allowing for an office worker subject to space limitations to sit on the chair 3 and utilize the abdominal fitness equipment provided. Structure of the present invention is described hereinafter:

An electric motor is installed interior of the main body 1 of the fitness equipment, and the main body 1 is disposed on a rear side of the chair 3. Vibrating belts 2 that are separately attached to two ends of the main body 1 can encircle a front side of the chair 3 and the abdomen or the waist of a user and bind together by means of hook and loop tapes, thus, when a switch of the main body 1 is actuated, the electric motor drives the vibrating belts 2 which thereby continuously vibrate, thus achieving effectiveness of abdominal body shaping while sitting on the chair 3.

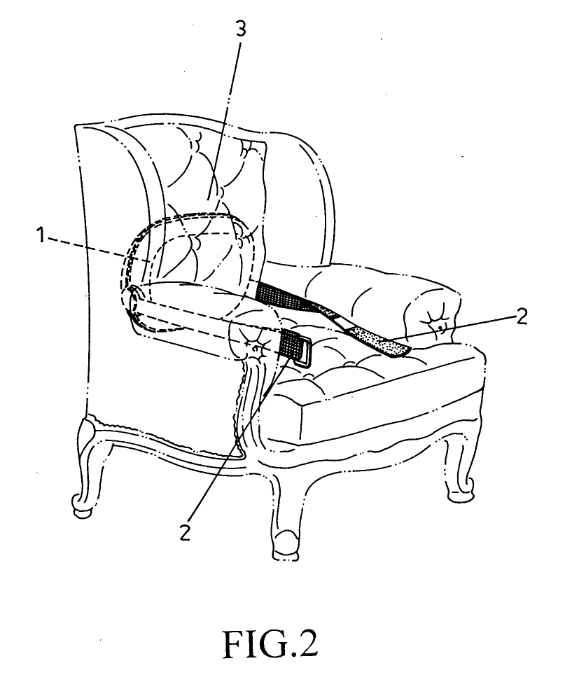

Referring to FIG. 2, which shows the main body 1 of the present invention already concealed interior of the chair 3 during process of production and manufacture of the chair 3, and only exposing a switch and the vibrating belts 2 lateral of the chair 3, similar to a safety belt as used in an airplane, and thereby forms a fitness chair provided with functionality of waist body shaping. Upon switching on the main body 1, the vibrating belts 2 wrapped round the abdomen of the user thus commences vibrating and thereby achieves effectiveness of body shaping therewith.

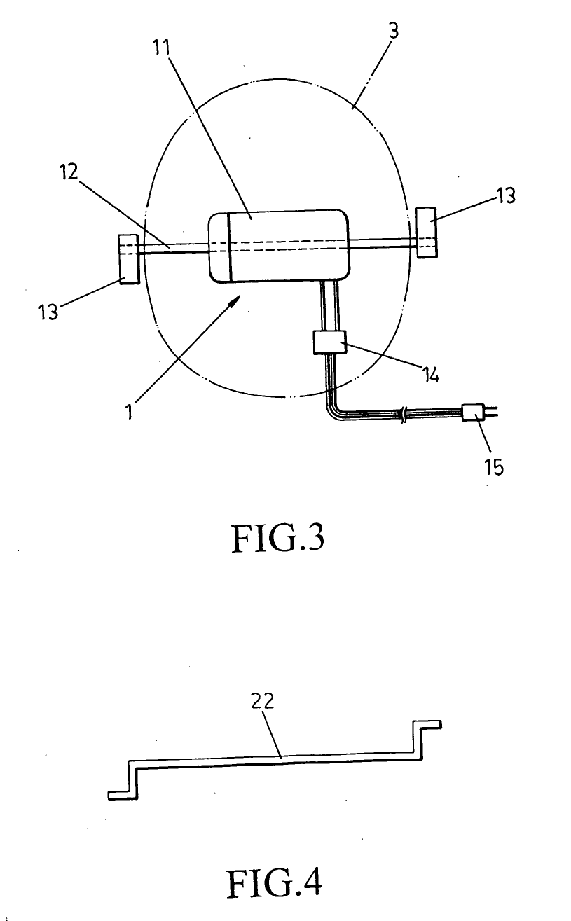

Referring to FIG. 3, which shows the main body 1 of the present invention constructed to comprise structural members including an electric motor 11, an axle 12, two vibrating blocks 13, a controller 14 and a plug 15. The electric motor 11 is mounted central of the axle 12, and two ends of the axle 12 separately connect to one of the vibrating blocks 13. The electric motor 11 is connected to the controller 14 by means of an electrical wire, and the controller 14 then connects to the plug 15 by a further electrical wire. After the plug 15 is plugged into a power supply, the electric motor 11 thereupon drives the axle 12, which thereby rotates the vibrating blocks 13 configured on the two ends of the axle 12, and accordingly the main body 1 actuates driving of the vibrating belts 2, which thus unceasingly vibrate. Referring to FIG. 4, which shows another embodiment of an axle 22 of the present invention configured to assume form of a crooked shape, and which thus eliminates need for the vibrating blocks 13 configured on two sides thereof.

In conclusion, the present invention improves upon shortcomings of the conventional abdominal fitness equipment, including large-size, space occupation, and difficulty in transporting; and instead provides the abdominal fitness equipment that is portable, is not restricted to specific locations, and effectuates usage merely by sitting on a chair.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An abdominal fitness equipment installable on a chair comprising:
a main body, interior of which is installed an electric motor, an axle, two vibrating blocks, a controller and a plug, wherein the electric motor is mounted central of the axle, and two ends of the axle separately connect to one of the vibrating blocks, the electric motor is connected to the controller by means of an electrical wire, and the controller then connects to the plug by a further electrical wire;
a vibrating belt, attached to two sides of the main body;
the main body can be installed on a rear side of a chair, and the vibrating belts encircle a front side of the chair and a user and can be bound together by means of hook and loop tapes, whereupon utilizing the electric motor of the main body to drive the vibrating belts to unceasingly vibrate, effectiveness of body shaping is thereby achieved.

2. The abdominal fitness equipment installable on a chair according to claim 1, wherein the main body can be installed interior of the chair.
